(19) United States
(12) Patent Application Publication
(10) Pub. No.: US 2008/0289451 A1
(43) Pub. Date: Nov. 27, 2008

(54) Mechanized Wrench Adapter

(75) Inventor: Narayanan M. Subramanian, Marietta, GA (US)

Correspondence Address: NARAYANAN M. SUBRAMANIAN, 4251 CREEK HAVEN DR., MARIETTA, GA, 30062, US

(73) Assignee: INVENTION DYNAMICS, LLC, Marietta, GA (US)

(21) Appl. No.: 11/850,879

(22) Filed: Sep. 6, 2007

Related U.S. Application Data
(60) Provisional application No. 60/939,550, filed on May 22, 2007.

(51) Int. Cl. B25B 17/00

(52) U.S. Cl. 81/57.29; 81/176.2

(57) ABSTRACT

A box wrench, also known as a ring spanner, to tighten or loosen nuts and bolts that can be attached to a screwdriver capable of taking different screwdriver bits or to a power tool such as a cordless screwdriver, corded screwdriver, pneumatic wrench etc.

### CROSS REFERENCE TO RELATED APPLICATIONS

This patent application claims priority from provisional U.S. patent application entitled “Mechanized Ring Spanner,” having application No. 60/939,550 filed on May 22, 2007, the contents of which are incorporated herein by reference.

### REFERENCE CITED

U.S. Pat. No. 6,193,624—Feb. 27, 2001—Lund; David R.
U.S. Pat. No. 5,927,156—Jul. 27, 1999—Landwehr, III; John W.
U.S. Pat. No. 5,860,335—Jan. 19, 1999—Lund; David R
U.S. Pat. No. 5,775,182—Jul. 7, 1998—Plakinger, Frank J.
U.S. Pat. No. 5,461,949—Oct. 31, 1995—Carver, Paul J.
U.S. Pat. No. 5,355,751—Oct. 18, 1994—Specht, Wolfgang
U.S. Pat. No. 5,331,869—Jul. 26, 1994—Webb; Daniel S.
U.S. Pat. No. 5,107,729—Apr. 28, 1992—Makhlouf; Samir B
U.S. Pat. No. 5,072,633—Dec. 17, 1991—Smith; Roger R.
U.S. Pat. No. 4,928,558—May 29, 1990—Makhlouf; Samir B.
U.S. Pat. No. 4,506,567—Mar. 26, 1985—Makhlouf; Samir B.
U.S. Pat. No. 4,322,989—Apr. 6, 1982—Garolis; Joseph J.
U.S. Pat. No. 4,171,651—Oct. 23, 1979—Dacunto; Alfred V.
U.S. Pat. No. 3,430,510—Mar. 4, 1969—Hendrickson; Otto

### FIELD OF INVENTION

The present invention relates to wrenches used to tighten or loosen nuts and bolts located in hard to reach spots. The invention more particularly relates to a mechanical adaptation for the wrenches such as box wrenches and socket wrenches for use with interchangeable-bit screwdrivers and power tools to loosen or tighten nuts and bolts in hard to reach places.

### BACKGROUND OF INVENTION

Socket wrenches are used widely to loosen and tighten hexagonal bolts and nuts. They are well adapted for use with interchangeable bit screwdriver type handles and power tools such as power screwdrivers and pneumatic drivers. But they cannot be used in tight spaces. Box wrenches, also known as closed end spanners and ring spanners, have been in use for a very long time to loosen or tighten hexagonal bolts and nuts in tight spaces. But these have not been adapted for use with power tools so far.

Some have tried to adapt power wrenches to access bolts and nuts in tight spots. U.S. Pat. No. 4,928,558, issued to Makhlouf, and U.S. Pat. No. 5,355,751, issued to Specht, use a series of communicating gears to transmit rotational torque from one end to the other where the socket is in communication with a nut or bolt. But the distance between the drive input at the proximate end and drive output at the distal end is fixed. If additional length is required, the user will have to buy a unit of a longer length. The cost of such a unit will be very high due to the number of gears used and assembly of those gears. This problem is not solved by U.S. Pat. No. 5,107,729, also issued to Makhlouf, where a shaft with gears at the proximal and distal ends are used to transmit power or U.S. Pat. No. 5,461,949, issued to Carver, where the power is transmitted using a timing belt. U.S. Pat. No. 5,927,156, issued to Landwehr and U.S. Pat. Nos. 5,860,335 and 6,193,624, issued to Lund also fail to address the problem noted above. U.S. Pat. No. 5,072,633, issued to Smith uses a chain drive between the drive input at the proximate end and drive output at the distal end. Though the inventor claims that the length can be adjusted, the chain length dictates the extension length. For longer extensions, the user will have to dismantle the assembly, inset a longer chain and reassemble the drive—a very cumbersome and time consuming process. U.S. Pat. Nos. 4,322,989, 4,171,651 and 3,430,510 suffer from using too many parts, causing the manufacturing cost to be high and increasing the number of points of failure.

### BRIEF SUMMARY OF INVENTION

The primary objective of the present invention is to come up with a modified wrench adapter that can be attached to interchangeable drive bit manual screwdrivers and to power screwdrivers such as electric screwdriver, pneumatic driver, hydraulic driver etc. so that hexagonal nuts, bolts and other types of fasteners located in hard to reach places can be tightened or loosened with ease.

Another objective of the present invention is to make it easy for the user to attach a readily available extension rod to the present invention, should more length be needed to reach the nut or bolt.

A third objective of the present invention is to have interchangeable wrench bits to reduce the weight and cost for users.

A fourth objective of the present invention is to make the unit with minimum number of parts so that the product is cost justified for the manufacturers to adopt it.

The foregoing objectives are attained by having industry standard interface parts and a simple gearbox to change the axis of rotation between the power screwdriver and the mechanized wrench adapter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a preferred embodiment of the mechanized wrench adapter. In this embodiment, the circumference of the box wrench has gear teeth cut in the form of a crown gear. A pinion, with its axis of rotation perpendicular to the axis of rotation of the crown gear, is in communication with the crown gear to rotate the box wrench.

FIG. 2 is another view of the same embodiment.

FIG. 3 is a perspective view of a second preferred embodiment of the mechanized wrench adapter. In this embodiment, the circumference of the box wrench has gear teeth cut to form a spur gear. A crown gear, with its axis of rotation perpendicular to the axis of rotation of the spur gear, is in communication with the spur gear to rotate the box wrench about the X-axis.

FIG. 4 is a perspective view of a third preferred embodiment of a mechanized wrench adapter to use with currently available socket wrenches.

FIG. 5 is another perspective view of FIG. 4 with a commercially available extension rod to extend the reach of the wrench.

FIG. 6 is a perspective view of a third preferred embodiment of a mechanized wrench adapter with interchangeable box wrench bits.

FIG. 7 is the perspective view of the preferred embodiment of FIG. 6 with the interchangeable bit having a different size box wrench to tighten or loosen a different size bolt or nut.

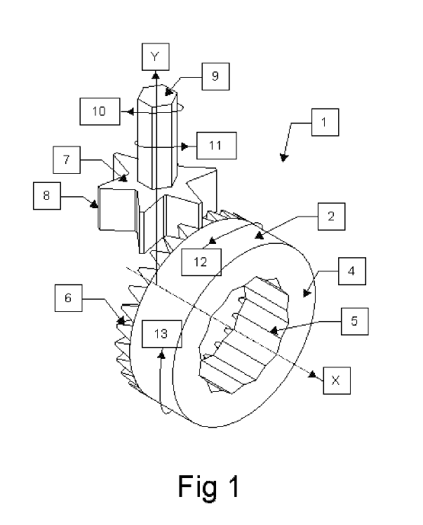

The numbering is kept consistent across FIG. 1 through FIG. 7 for clarity. Hence like reference numerals designate like parts.

### DETAILED DESCRIPTION OF THE INVENTION

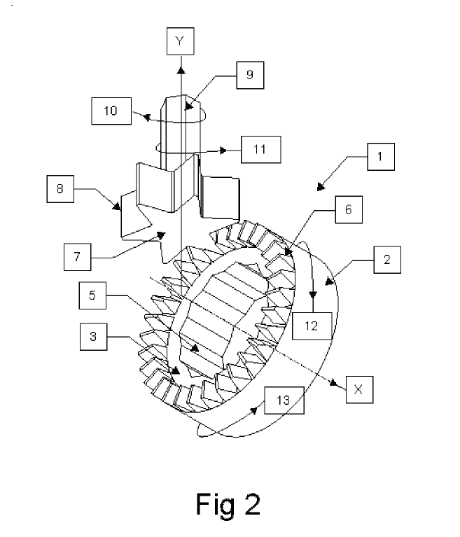

FIG. 1 refers to a preferred embodiment of the present invention of a mechanized wrench adapter with its internal parts revealed. FIG. 2 is another view of the same embodiment depicted in FIG. 1. The whole unit is generally referred to as 1. Unit 1 has a crown gear 2 with two flat, circular surfaces labeled 3 and 4. Gear teeth 6 project from surface 3. The gear teeth are arranged along the circumference of surface 3. The shape of the box wrench that communicates with a given nut or bolt is cut out from the center of crown gear 2. The shape of the box wrench is marked 5 in FIG. 1 and FIG. 2. The crown gear has a module, M, which, in the gear industry, is defined as the ratio of the pitch diameter in millimeters to the number of teeth in the gear. Pitch diameter is the diameter of the pitch circle inscribed by the gear teeth at the point of contact with another gear of the same module. The crown gear has its axis of rotation about the X-axis in FIG. 1 and FIG. 2. A pinion 7, with teeth 8, is placed along an axis perpendicular to the X-axis such that teeth 6, in crown gear 2, communicate rotatably along the pitch circle with teeth 8 in pinion 7. In FIG. 1 and FIG. 2, this perpendicular axis is denoted as the Y-axis. The module of pinion 7 is the same as the module of crown gear 2. The pinion has a shaft 9 extending on one side of the pinion, on the side farther away from the axis of rotation of the crown gear. Depending on the power drive for which this unit is made, shaft 9 can have a circular, square, hexagonal or any other desired cross section. In FIG. 1 and FIG. 2 the shaft is shown with a hexagonal cross section.

Shaft 9 is attached to a power driver such as a power screwdriver. When the power screwdriver is rotated in a clockwise direction about the Y-axis, shaft 9 and pinion 7 rotate in a clockwise direction, represented by arrow 10. The pinion teeth 8, in turn, push the crown gear teeth 6, to rotate the crown gear about the X-axis in the direction marked 12. This causes the nut or bolt, which is communicating with the box wrench, to rotate about the X-axis, in the direction marked 12. In this example, let it result in the tightening of the nut or bolt.

When the power screwdriver is rotated in a counter-clockwise direction about the Y-axis, shaft 9 and pinion 7 rotate in a counter-clockwise direction, represented by arrow 11. The pinion teeth 8, in turn, push the crown gear teeth 6, to rotate the crown gear about the X-axis in the direction marked 13. This causes the nut or bolt, which is communicating with the box wrench, to rotate about the X-axis, in the direction marked 13. In this example, this will loosen the nut or bolt.

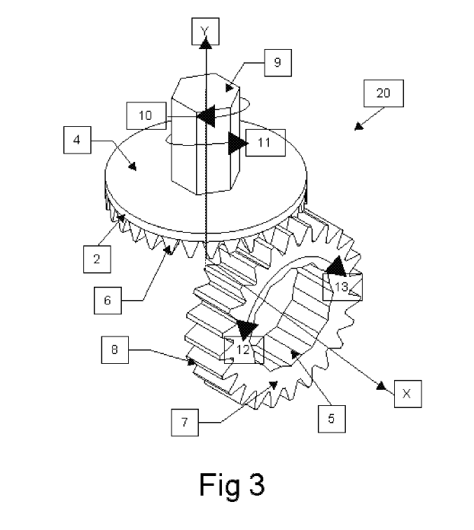

FIG. 3 refers to a second preferred embodiment of the present invention of a mechanized wrench adapter with its internal parts revealed. The whole unit is generally referred to as 20. Unit 20 has a crown gear 2, with gear teeth 6 projecting from one of the flat circular surfaces. The crown gear has a module, M. The crown gear has a shaft 9 extending from surface 4. The crown gear has its axis of rotation about the Y-axis. Depending on the power drive for which this unit is made, shaft 9 can have a circular, square, hexagonal or any other desired cross section. In FIG. 3, the shaft is shown with a hexagonal cross section. A spur gear 7, with teeth 8, is placed along an axis perpendicular to the Y-axis such that teeth 6, in crown gear 2, communicate rotatably with teeth 8 in spur gear 7 along the pitch circle. In FIG. 3, this perpendicular axis is denoted as the X-axis. The module of spur gear 7 is the same as the module of crown gear 2. The box wrench is cut out from the center of spur gear 7. This is marked 5 in FIG. 3.

Shaft 9 is attached to a power driver such as a power screwdriver. When the power screwdriver is rotated in a clockwise direction about the Y-axis, crown gear 2 rotates in a clockwise direction, represented by arrow 10. The crown gear teeth 6, in turn, push the spur gear teeth 8 to rotate the spur gear about the X-axis in the direction marked 12. The nut or bolt, which is in communication with the box wrench, is also rotated about the X-axis, in the direction marked 12. In this example, let it result in the tightening of the nut or bolt.

When the power screwdriver is rotated in a counter-clockwise direction about the Y-axis, the crown gear rotates in a counter-clockwise direction, represented by arrow 11. The crown gear teeth 6, in turn, push the spur gear teeth 8, to rotate the spur gear about the X-axis in the direction marked 13. This will loosen the nut or bolt that is in communication with the box wrench.

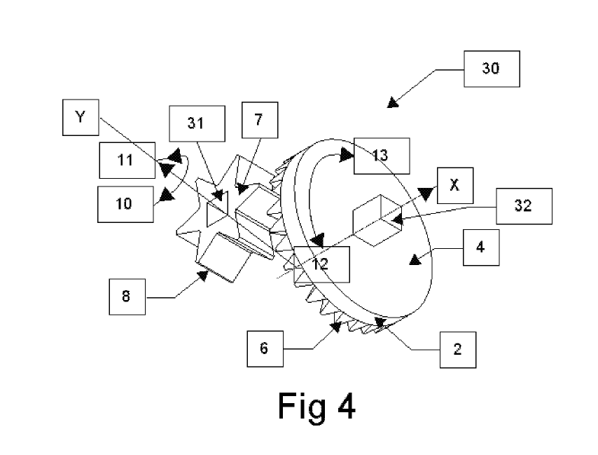

FIG. 4 refers to a third preferred embodiment of the present invention of a mechanized wrench adapter with its internal parts revealed. The whole unit is generally referred to as 30. Unit 30 has a crown gear 2, with gear teeth 6 projecting from one of the flat circular surfaces. The crown gear has a module, M. The crown gear has a lug, 32, extending from surface 4. The crown gear has its axis of rotation about the X-axis. A pinion 7, with teeth 8, is placed along an axis perpendicular to the X-axis such that teeth 6, in crown gear 2, communicate rotatably with teeth 8 in pinion 7 along the pitch circle. In FIG. 4, this perpendicular axis is denoted as the Y-axis. The module of pinion 7 is the same as the module of crown gear 2. A square hole is cut out in the center of pinion 7 to receive the lug from the power driver. The lug in the power driver is similar to lug 32. The square hole is marked 31 in FIG. 4.

By mating the lug in the power driver with hole 31 in the pinion, the power driver is attached to unit 30. When the power driver is rotated in a clockwise direction about the Y-axis, pinion 7 rotates in a clockwise direction, represented by arrow 10. Pinion teeth 8, in turn, push the crown gear teeth 6 to rotate the crown gear about the X-axis in the direction marked 12. The socket which is attached to the lug 32 also turns in the direction 12. The nut or bolt, which is in communication with the socket, is thus rotated about the X-axis, in the direction marked 12. In this example, let it result in the tightening of the nut or bolt.

When the power driver is rotated in a counter-clockwise direction about the Y-axis, the pinion rotates in a counter-clockwise direction, represented by arrow 11. The pinion teeth 8, in turn, push the crown gear teeth 6, to rotate the crown gear about the X-axis in the direction marked 13. This will loosen the nut or bolt that is in communication with the socket.

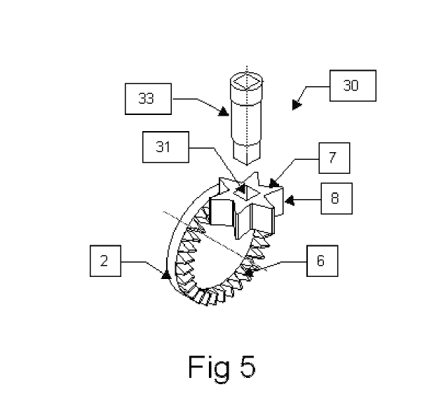

FIG. 5 is another view of the same embodiment depicted in FIG. 4 along with an extension rod, 33. Rod 33 is any commercially available extension rod that is made for commercially available socket wrenches. When the nut or bolt to be tightened or loosened is seated deep inside, the extension rod is used between the pinion and the power drive to extend the reach of the wrench.

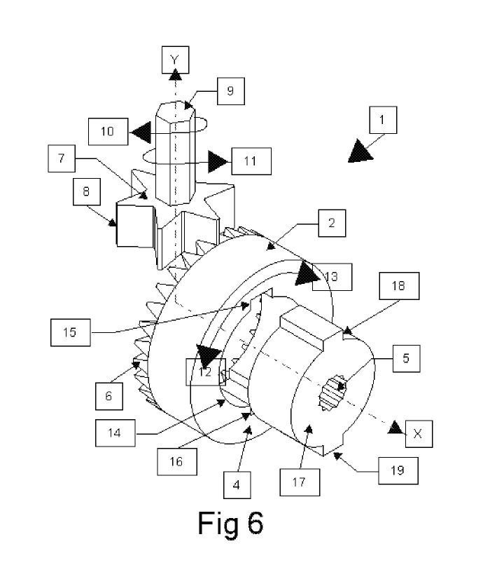

FIG. 6 refers to a fourth preferred embodiment of the present invention of a mechanized wrench adapter with its internal parts revealed. The unit is similar to the one revealed in FIG. 1 and FIG. 2 except for the box wrench. Instead of each mechanized wrench adapter having a specific sized box wrench slot to fit one particular size of bolt or nut, in this embodiment, the center of crown gear 2 is cut out to be of a standard shape and size so that it can take in interchangeable box wrench bits. In FIG. 6, crown gear 2 has a cylinder 14, cut from the center. It also has two anti-rotation notches cut on the circumference of the cylinder. These anti-rotation notches are marked 15 and 16. Notch 15 is located diametrically opposite notch 16. An interchangeable cylinder 17, has two tabs protruding from the circumference of the cylinder, marked 18 and 19. Tab 18 is located diametrically opposite tab 19. Cylinder 17 has a box wrench, 5, cut in its center. The diameter of cylinder 17 is slightly smaller than the diameter of cylinder 14 in crown gear 2. Similarly tabs 18 and 19 are slightly smaller than the anti-rotation notches 15 and 16. This enables the cylinder 17 to slide into cylindrical cut out 14 in crown gear 2 without it being too loose that it can easily fall out. The size of box wrench 5 is based on the nut or bolt on which it will be used.

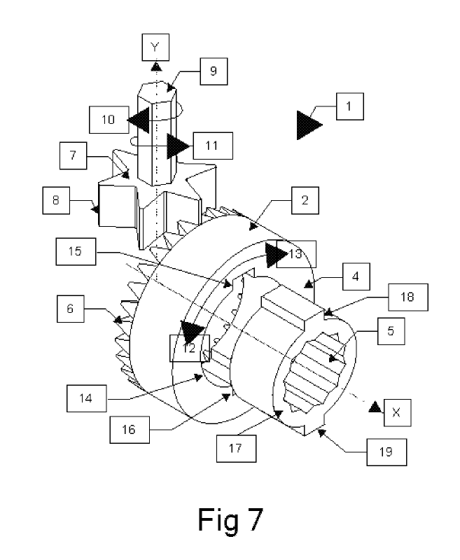

FIG. 7 is the same as FIG. 6, except that the size of box wrench 5 is different. Thus it can be seen that multiple box wrench bits can be used with a single mechanized wrench adapter to work on bolts and nuts of varied sizes. This interchangeable design can be extended to the unit shown in FIG. 3 or any other mechanism that changes the axis of rotation between the input and output. It can also be used as an improvement on existing box wrenches.

What I claim:

1. A torque transferring device comprising:
1. a first drive means;
2. a second drive means communicating rotatably with said first drive means to change the axis of rotation of said second drive means with respect to said first drive means.

2. A first drive means of claim 1 where said first drive means has a shaft.

3. A second drive means of claim 1 where said second drive means has an annular jaw means.

4. A first drive means of claim 2 where said first drive means is a pinion.

5. A second drive means of claim 3 where said second drive means is a crown gear.

6. An annular jaw means of claim 3 where said jaw means mate with standard bolt and nut.

7. A first drive means of claim 2 where said first drive means is a crown gear.

8. A second drive means of claim 3 where said second drive means is a spur gear.

9. A first drive means of claim 2 where said first drive means is a bevel gear.

10. A second drive means of claim 3 where said second drive means is a bevel gear.

11. An annular jaw means of claim 3 where said jaw means is a hole with anti-rotation notch means.

12. An annular jaw means of claim 11 where said jaw means can receive a multitude of jaw bits.

13. A jaw bit of claim 12 where said jaw bit has anti-rotation tab means.

14. A jaw bit of claim 13 where said jaw bit mates with said annular jaw means of claim 12.

15. Anti-rotation tab means of claim 13 where said anti-rotation tab means mate with said anti-rotation notch means of claim 11.

16. A jaw bit of claim 14 where said jaw bit has an annular jaw hole to mate with said standard bolt and nut of claim 6.

17. A shaft means of claim 2 where the cross-section of said shaft means is a circle.

18. A shaft means of claim 2 where the cross-section of said shaft means is a square.

19. A shaft means of claim 2 where the cross-section of said shaft means is a hexagon.

20. A shaft means of claim 2 where the cross-section of said shaft means is a polygon.

21. A first drive means of claim 1 where said first drive means has a hole.

22. A second drive means of claim 1 where said second drive means has a lug means.

23. A hole means of claim 21 where said hole means fits standard socket wrench lug.

24. A lug means of claim 22 where said lug means fits standard socket hole.

25. A first drive means of claim 21 where said first drive means is a pinion.

26. A first drive means of claim 21 where said first drive means is a crown gear.

27. A first drive means of claim 21 where said first drive means is a bevel gear.

28. A second drive means of claim 22 where said second drive means is a crown gear.

29. A second drive means of claim 22 where said second drive means is a spur gear.

30. A second drive means of claim 22 where said second drive means is a bevel gear.
